(19) United States
(12) Patent Application Publication
(10) Pub. No.: US 2013/0138687 A1
(43) Pub. Date: May 30, 2013

(54) METHOD AND SYSTEM FOR OBSERVING AND ENHANCING COMPLIANCE WITH INSTRUCTION VIA A SOCIAL NETWORK

(71) Applicant: International Business Machines Corporation, Armonk, NY (US)

(72) Inventors: Mark JH HSIAO, Taipei (TW); Pei-Yun S. HSUEH, Hawthorne, NY (US); Ci-Wei LAN, Keelung City (TW); Yi-Fang LEE, Taipei (TW); Pao-Chuan LIAO, Taipei (TW); Sreeram RAMAKRISHNAN, Yorktown Heights, NY (US)

(73) Assignee: INTERNATIONAL BUSINESS MACHINES CORPORATION, Armonk, NY (US)

(21) Appl. No.: 13/690,692

(22) Filed: Nov. 30, 2012

(30) Foreign Application Priority Data
Nov. 30, 2011 (TW) 100143898

(51) Int. Cl. G06F 17/30

(52) U.S. Cl. CPC G06F 17/30979
USPC 707/769

(57) ABSTRACT

A method and a system for observing and enhancing compliance with instructions via a social network by a computer system are provided. The method includes the following steps:
(a) providing a first query about compliance of a first instruction;
(b) creating a sending list according to social network information provided by an object of the first instruction;
(c) sending the first query according to the sending list;
(d) receiving from the sending list replies in response to the first query, wherein each reply selectively indicates one of multiple degrees of compliance;
(e) creating an effective sending list from the sending list according to the compliance indicated by the replies in step (d);
(f) providing a second query about compliance of a second instruction; and
(g) sending the second query according to the effective sending list.

This application is based on and claims the benefit of priority from Taiwan Patent Application 100143898, filed on Nov. 30, 2011.

### BACKGROUND OF THE INVENTION

1. Field of the Invention

The present invention relates to methods and systems for observing and enhancing compliance with instructions via a social network, and more particularly, to a method and a system for observing and enhancing, via a social network, patients' compliance with instructions pertaining to medical care and hygiene education.

2. Description of the Prior Art

At present, there are plenty of methods for observing and thereby enhancing compliance with instructions, and the methods are applicable to goals related to education or medical care (or a combination thereof.) Take medical care as an example, after giving a diagnosis and a prescription to a patient, a physician gives advice, in a medical care instruction, to the patient on accommodating the patient's diet or lifestyle. In some circumstances, diseases, such as obesity and diabetes, are more efficiently cured by altering patients' diet or lifestyle than medication.

However, plenty of patients (especially those patients who receive in-home caregiver services) neither follow medical care instructions strictly nor understand the medical care instructions sufficiently for observance thereof to be possible; as a result, it is difficult for the patients to recover from their illness, thereby causing a waste of medical care resources.

In view of this, U.S. Pat. No. 7,287,031 puts forth a method for enhancing patients' compliance with medical care instructions. Furthermore, U.S. published patent applications 2009/0144084 and 2010/0299156 provide methods for observing or evaluating patients' feedback on medical care instructions or hygiene education-related information.

### SUMMARY OF THE INVENTION

Conventional methods for observing or evaluating compliance with instructions rely mostly upon feedback directly provided by an object receiving the instructions; as a result, it is doubtful whether the results of observation or evaluation are objective. In view of this, an embodiment of the present invention is characterized in that compliance with instructions is observed or evaluated by means of feedback provided by a social network of objects receiving instructions, such as medical care instructions, for example, patients receiving medical care instructions.

The term “a social network” used herein should not only be interpreted as “a social network website” or connection of “Internet-based social network services,” but also mean genuine interpersonal relationship in daily life. The present invention will apply to whatever situations, provided that the aforesaid interpersonal relationship and members therein are recognized by and recorded in a computer system by means of digital data processing, and provided that the computer system is able to communicate with the members in the interpersonal relationship by means of digital data processing (including but not limited to instant messages, emails, and SMS.)

Although instructions described hereunder are exemplified by medical care instructions, persons skilled in the art understand that the present invention is not limited to the above-mentioned. For example, the present invention also applies to general education. Hence, the terms “instructions” and “instruction” used herein do not necessarily mean that an object receiving an instruction is required to commit a specific act or not to commit a specific act. In some situations, the terms “instructions” and “instruction” used herein merely require an object receiving an instruction or instructions to understand the details of knowledge or information carried by the instruction/instructions.

For example, given a patient's consent, the patient's family members or friends can evaluate the patient's compliance with medical care instructions by talking to and interacting with the patient in daily life, so as to draw a conclusion on questions, such as, whether the patient fully understands the medical care instructions and behaves in a manner in compliance with the requirements of the medical care instructions, such that feedback-related data can be entered into a computer system to facilitate a subsequent digital data processing process.

The aforesaid approach not only leads to objective observation results but also enhances patients' medical care instruction compliance indirectly. It is because the aforesaid approach enables the patients' family members or friends to manifest a supportive or anticipatory gesture toward the patients, thereby motivating the patients to comply with medical care instructions better. However, a point to note is that it is common sense to use patients' social networks to reinforce the patients' resolve to follow medical care instructions or hygiene education instructions strictly, and thus related details are not described herein for the sake of brevity. In addition to family members' support mentioned above, for example, there are some random and anonymous social networks useful to abstainers, such as Alcoholics Anonymous (http://www.aa.orq).

Unlike Alcoholics Anonymous that builds a social network randomly, the present invention discloses that a social network is specified by an object receiving an instruction (for example, a patient receiving a medical care instruction), so the social network is well-known or at least known by objects receiving instructions. However, not all the members of a social network are willing to be engaged in active participation in the observation or evaluation of medical care instruction compliance even though the social network members are familiar with the instructions. Furthermore, not all the members of a social network are influential in terms of reinforcing patients' resolve to follow medical care instructions strictly.

In view of this, a method for observing and enhancing compliance with instructions via a social network according to an embodiment of the present invention involves: selecting social network members who have ever reported a high degree of instruction compliance, i.e., good results, of the patients; treating them as members (hereinafter referred to as “effective members”) who are willing to participate in observation of medical care instruction compliance and are influential in terms of reinforcing patients' resolve to follow medical care instructions strictly; observing instruction compliance by means of the “effective members”; and enhancing a patient's compliance with medical care instructions through the actual interaction between the patient and the effective members.

A method for observing and enhancing compliance with instructions via a social network according to another embodiment of the present invention involves: determining that “effective members” in a social network belong to specific social network type (for example classmates, colleagues, or family members) in a preceding situation; and linking the specific social network type and instruction attribute (for example, an attribute about food and drinks, or an attribute about lifestyle, and a medical care instruction), an instruction-receiving object's attribute (for example, a patient's attribute about age or occupation) to treat them as a reference for later use. Hence, in a subsequent situation, even for different patients, if their medical care instruction attributes and/or patient attributes are identical to the medical care instruction attributes and/or patient attributes in the preceding situation, it will be feasible to make reference to the specific social network type determined in the preceding situation so as to screen beforehand the social network information provided by the patients and thereby select the “effective members” efficiently in the subsequent situation.

The present invention, in an embodiment thereof, provides a method for observing and enhancing compliance with instructions via a social network by a computer system. The method comprises the steps of: (a) providing a first query about compliance of a first instruction; (b) creating a sending list according to social network information provided by an object of the first instruction; (c) sending the first query according to the sending list; (d) receiving from the sending list replies in response to the first query, wherein each reply selectively indicates one of multiple degrees of compliance; (e) creating an effective sending list from the sending list according to the compliance indicated by the replies in step (d); (f) providing a second query about compliance of a second instruction; and (g) sending the second query according to the effective sending list.

The present invention, in another embodiment thereof, provides a method for observing and enhancing compliance with instructions via a social network by a computer system. The method comprises the steps of: (a) providing a database predefining a plurality of object attributes and a plurality of social network types; (b) selecting an object attribute of an object of a first instruction from the plurality of object attributes; (c) providing a first query about compliance of the first instruction; (d) creating a first sending list according to social network information provided by the object of the first instruction, and sorting the first sending list by social network type; (e) sending the first query according to the first sending list; (f) receiving from the first sending list replies in response to the first query, wherein each reply selectively indicates one of multiple degrees of compliance; (g) calculating the compliance indicated by each social network type in the first sending list according to the replies in step (f) so as to select an effective social network type from the plurality of social network types and associate the object attribute of the object of the first instruction with the effective social network type; (h) providing a second query about compliance of a second instruction, and selecting an object attribute of an object of a second instruction from the plurality of object attributes; and (i) creating a second sending list according to a portion of the social network information provided by the object of the second instruction and sending the second query according to the second sending list, wherein the portion of the social network information belongs to the effective social network type, on condition that the object attribute of the object of the first instruction and the object attribute of the object of the second instruction are identical.

The present invention provides, in yet another embodiment thereof, a method for observing and enhancing compliance with instructions via a social network by a computer system. The method comprises the steps of: (a) providing a database predefining a plurality of instruction attributes and a plurality of social network types; (b) selecting an instruction attribute of a first instruction from the plurality of instruction attributes; (c) providing a first query about compliance of the first instruction; (d) creating a first sending list according to the social network information provided by the object of the first instruction, and sorting the first sending list by social network type; (e) sending the first query according to the first sending list; (f) receiving from the first sending list replies in response to the first query, wherein each reply selectively indicates one of multiple degrees of compliance; (g) calculating the compliance indicated by each social network type in the first sending list according to the replies in step (f) so as to select an effective social network type from the plurality of social network types and associate the instruction attribute of the first instruction with the effective social network type; (h) providing a second query about compliance of a second instruction, and selecting an instruction attribute of a second instruction from the plurality of instruction attributes; and (i) creating a second sending list according to a portion of the social network information, belonging to the effective social network type, provided by the object of the second instruction, and sending the second query according to the second sending list, on condition that the instruction attribute of a first instruction and instruction attribute of a second instruction are identical.

According to another embodiment of the present invention, the present invention provides a computer system comprising a memory and a processing unit. The memory stores a computer executable instruction. The processing unit executes the computer executable instruction so as to implement the aforesaid methods.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a block diagram of a computer system according to specific embodiments of the present invention; and

FIG. 2 through FIG. 7 are flowcharts of specific embodiments of the present invention.

### DETAILED DESCRIPTION OF THE EMBODIMENTS

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a computer system, a method or a computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the users computer, partly on the users computer, as a stand-alone software package, partly on the user's computer and partly on a remote computer or entirely on the remote computer or server. In the latter scenario, the remote computer or server may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

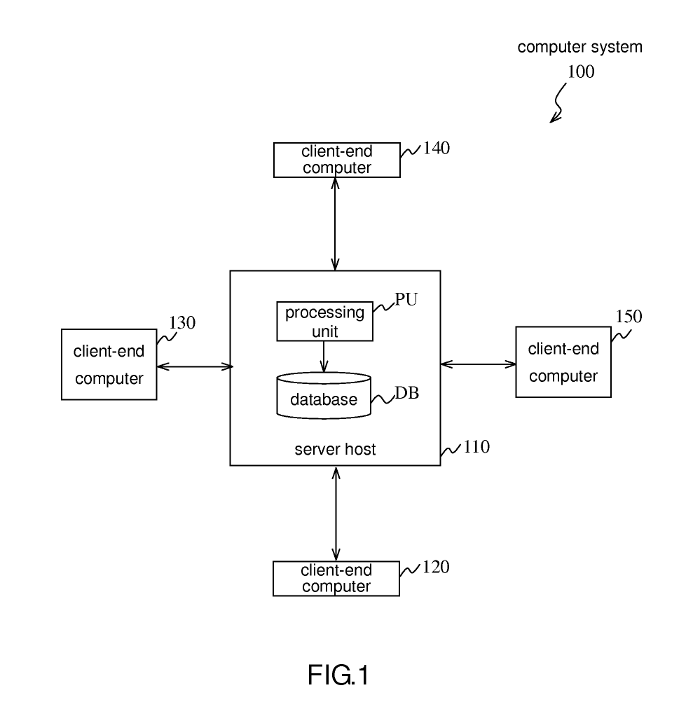

Referring now to FIG. 1 through FIG. 7, computer systems, methods, and computer program products are illustrated as structural or functional block diagrams or process flowcharts according to various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

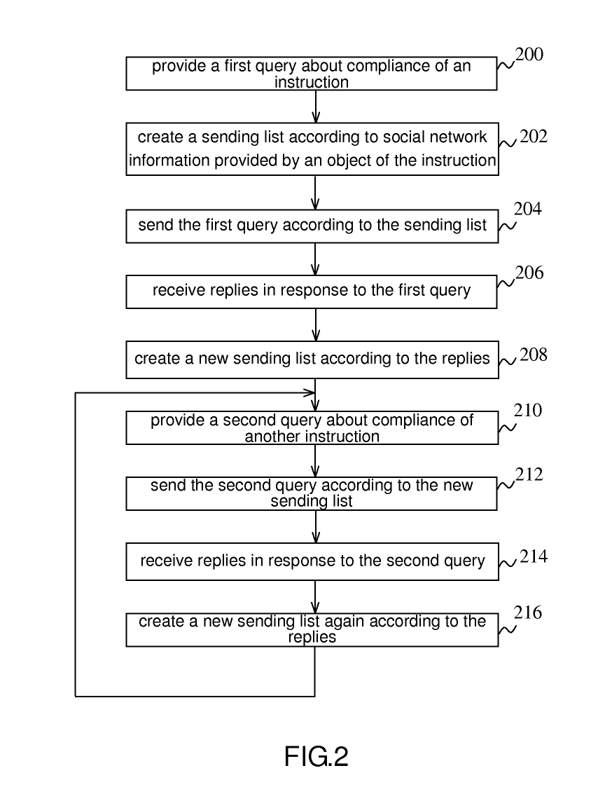

FIG. 1 is a schematic view of the structure of a system 100 according to a specific embodiment of the present invention, such that FIG. 1 enables persons skilled in the art to gain insight into the present invention rather than restricts the scope of the present invention. In an exemplary embodiment, the system 100 includes a server 110, one or more client-end computers 120, 130, 140, 150 (such as a personal computer, a notebook computer, or a mobile electronic device). The server 110 has a processing unit PU and a database DB to execute methods illustrated through FIG. 2 through FIG. 7 The client-end computers 120, 130, 140, 150 are connected to the information center server 110 via a network (not shown).

According to the present invention, the client-end computers 120, 130, 140, and 150 are electronic products for executing applications to provide an instant message, an e-mail, or a short message, or electronic products for executing other applications to dispatch information, such as desktop computers, notebook computers, terminal apparatuses, mobile phones, or personal digital assistants. The client-end computers can also execute applications like word processing services or browsers. In an exemplary embodiment, the client-end computer is a general desktop computer including: a processor for executing various applications; a storing device for storing various information and program codes; a display device; a communication and output/input device for use as an interface for communication with the users; and peripheral elements or other elements with specific purposes. In other embodiments, the present invention may also be implemented in other manners and thus require more other devices/elements or less other devices/elements.

Likewise, the server 110 can come in the form of a general computer, a computer with a special purpose, a high-level workstation, or a large host computer as needed, without affecting the implementation of the present invention. The required network can also come in a connection of any type, including a wide area network (WAN) or a local area network (LAN) with static IP, or a temporary connection to the Internet through an Internet service provider (ISP), whether by cable connection or by wireless connection. Persons skilled in the art are able to understand that the network can also have other hardware and software elements (such as an additional computer system, a router, or a firewall) not shown in the accompanying drawings.

Each of the client-end computers for executing various applications (such as an instant message system, an e-mail system, or a short message system) for dispatching information includes an information plug-in and thus can interact with the server 110.

It should be noted that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The present invention is hereunder illustrated with several simple embodiments and is especially exemplified by medical care instructions. As mentioned earlier, persons skilled in the art should understand that the present invention is not limited to the embodiments below.

The present invention does not limit how a physician gives a medical care instruction to a patient. In this regard, in a well-known scenario of an outpatient clinic, the physician gives a medical care instruction orally. Alternatively, patients access medical care instructions by means of digital data processing according to the prior art. The disclosure contained in the embodiments of the present invention is directed to observing and enhancing patients medical care instruction compliance via a social network by a computer system after a physician has given a medical care instruction to a patient in the aforesaid manner.

Preferably, a server 110 shown in FIG. 1 is connected to a medical history system (not shown) of a hospital or a clinic for accessing the contents of diagnosis and medical care instructions given by physicians to patients. Related details are disclosed in U.S. Pat. No. 7,287,031 and thus are not described in detail herein for the sake of brevity.

### First Embodiment

FIG. 2 is a flow chart of a method for observing and enhancing compliance with instructions via a social network according to an illustrative embodiment of the present invention, wherein the method applies to a system 100 shown in FIG. 1.

Step 200: provide a query about compliance of a medical care instruction. As mentioned earlier, the present invention relates to observing or evaluating patients' medical care instruction compliance via the patients' social network members (for example, family members, friends, or colleagues). Hence, in this step, the server 110 provides a query about compliance of a medical care instruction according to the contents of the medical care instruction. For example, if a patient is diagnosed with “hypertension” and a medical care instruction corresponding thereto is “quit smoking and be restricted to low-sodium food and drinks (i.e., on low-sodium diet),” a query prepared and provided by the server 110 to the patient's family members, friends, or colleagues can be, for example, “the patient's medical care instruction requires the patient to quit smoking, so has the patient quit smoking?” or “the patient's medical care instruction requires the patient to quit smoking, so please score the progress made by the patient in quitting smoking.”

However, in plenty of situations, medical care instruction compliance or the other instruction compliance depends on a good understanding of the contents of the instruction. For example, it is possible that the term “low-sodium food and drinks” eludes the man in the street. Hence, another example of the query provided by the server 110 is “the patient's medical care instruction requires the patient to take low-sodium food and drinks, so does the patient understand that low-sodium food and drinks means that daily sodium intake should not exceed 6 grams?” or “the patient's medical care instruction requires the patient to take low-sodium food and drinks, so does the patient understand that cheese and sausage are high-sodium foods?”

From a design perspective, a query sent from the server 110 has to facilitate patients' description of the degrees of compliance with medical care instructions. That is to say, its replies (for example, yes/no or scores) have to be suitable for being processed by digital data processing.

Preferably, to reply to a query sent from the server 110, patients' family members and friends have to take the initiative in observing the patients or even interact with the patients to thereby influence the patients and enhance patients' compliance with medical care instructions.

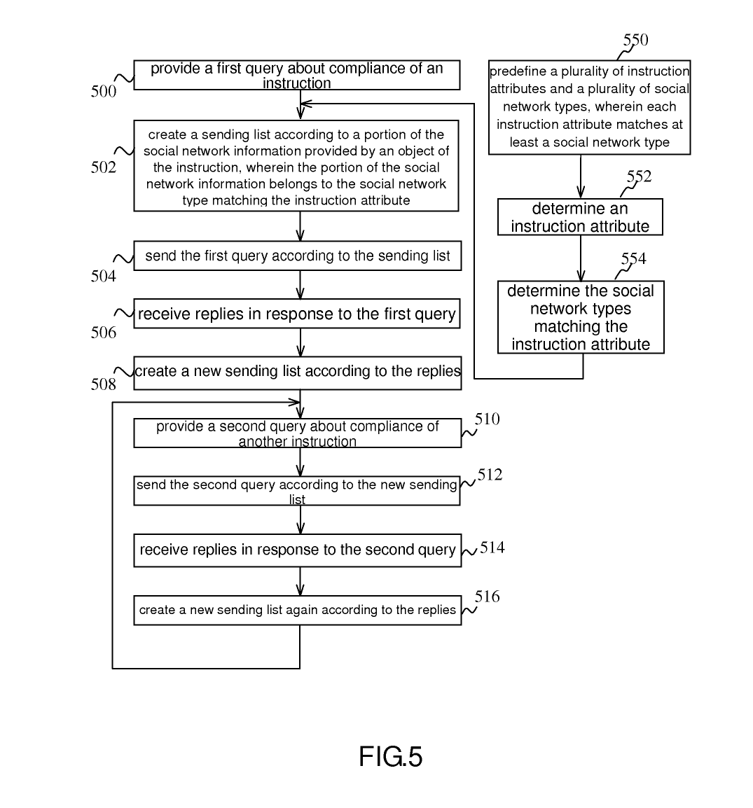

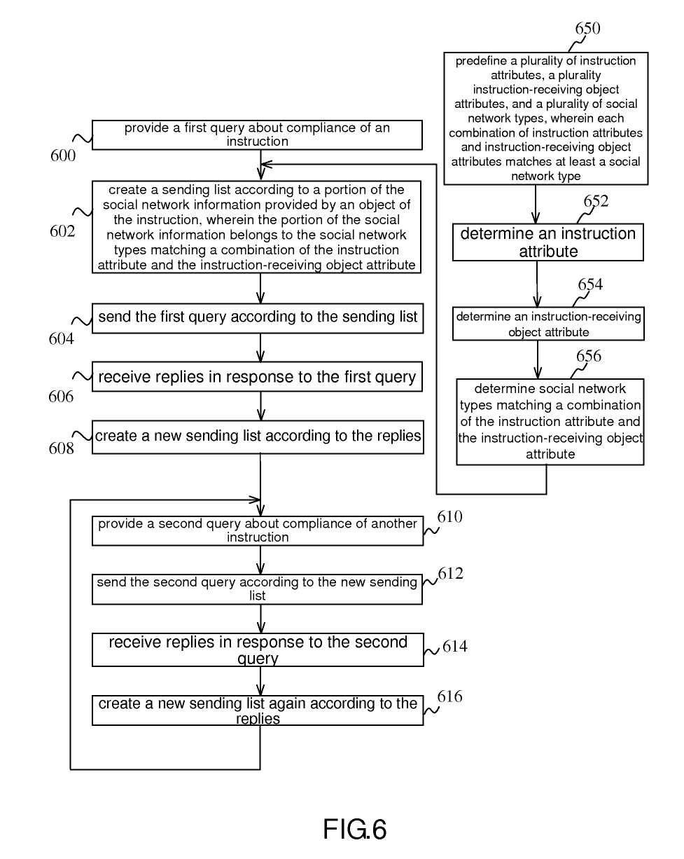

Step 202: create a sending list and a sending schedule according to social network information provided by an object (that is, a patient) receiving a medical care instruction, wherein the sending list and the sending schedule are for use in sending the aforesaid query. In an embodiment, patients may independently enter their social network information into the server 110 so as to create a sending list. In this regard, the patients can enter the data and items of communication means pertaining to social network members one by one in a way similar to creating a “phone directory” according to the prior art. Alternatively, the patients may authorize the server 110 to access their user accounts provided by specific social network service providers, such as Facebook™ and Google Plus™, so as to obtain social network information related to the patients and kept by the social network service providers in order to create a sending list or even allow the server 110 to communicate with one of the social network members via the social network service providers. In another embodiment, the server 110 screens, by preset criteria, social network information provided by patients rather than puts all the members of a patient-provided social network in a sending list. Related details are described in the fourth embodiment (FIG. 5) and the fifth embodiment (FIG. 6) below.

Step 204: send, according to sending list, the query provided in step 200. The query is sent to client-end computers 120, 130, 140 and 150 (shown in FIG. 1) of the social network members enumerated in the sending list by means including but not limited to instant messages, emails, SMS, and the aforesaid social network service providers. After receiving the query, a social network member may selectively give a reply according to his or her observation of a patient so as to indicate an observed degree of compliance manifested by the patient.

Furthermore, it is not necessary for a social network member to give a prompt reply after receiving the query. For example, it is feasible for a social network member to interact with patients within a period of time specified in the query to show his or her support for or expectation of the patients, so as to enhance the patients' compliance with medical care instructions before giving a reply about the extent of improvement in patients' medical care instruction compliance.

Furthermore, a social network member sends a reply to the server 110 by means including but not limited to instant messages, emails, SMS, and the aforesaid social network service providers.

Step 206: the server 110 receive replies from social network members enumerated in the sending list. As mentioned earlier, each reply (such as yes/no or a score) received by the server 110 can be processed by digital data processing to express the result of observation or evaluation performed by each social network member on patients' degrees of instruction compliance. For example, the server 110 uses value “1” to indicate that the reply is “yes” and the value “0” to indicate that the reply is “no”, or uses values “0”, “1”, “2” to indicate scores (from the lowest to the highest) so as to indicate different degrees of compliance described in a reply. If a portion of the members enumerated in a sending list does not give any reply, the “not replying” portion of the members can be either ignored or treated as having yielded an observation result indicating the lowest degree of compliance, for example, using value “0” to indicate “not replying”. Accordingly, the server 110 keeps a record about patients' degrees of compliance with regard to each social network member enumerated in the sending list. Referring to Table 1 below, social network members enumerated in the sending list are denoted by A, B, C, D. A point to note is that Table 1 is exemplified by a simple scenario illustrative of the present invention.

TABLE 1

| social network | degree of |
|---|---|
| member | compliance |
| A | 0 |
| B | 1 |
| C | 1 |
| D | 0 |

Step 208: the server 110 performs a digital data processing process on patients' degrees of compliance (i.e., the so-called replies) observed by the social network members (i.e., A, B, C, D) enumerated in the aforesaid Table 1. In this embodiment, the patients' compliance degree value “1” observed by social network members B, C is higher than the patients' compliance degree value “0” observed by social network members A, D, thereby indicating that social network members B, C observe a higher patients' compliance degree value than social network members A, D do. Hence, the server 110 can further put social network members B, C in a new sending list which is also known as an “effective sending list” (as opposed to the initial sending list.)

Step 210: provide another query about medical care instruction compliance. A point to note is that “another query” in step 210 and the query in step 200 can have the same contents when directed to identical medical care instructions. Alternatively, “another query” in step 210 and the query in step 200 can have different contents when directed to identical medical care instructions. Alternatively, “another query” in step 210 and the query in step 200 can even have identical or different contents when directed to different medical care instructions.

Step 212: send the query provided in step 210 according to the new sending list (i.e., social network members B, C) of step 208.

Step 214: the server 110 receives replies from social network members enumerated in the new sending list, as shown in Table 2 below.

TABLE 2

| social network | degree of |
|---|---|
| member | compliance |
| B | 0 |
| C | 1 |

Step 216: the patients' compliance degree value “1” observed by social network member C is higher than the patients' compliance degree value “0” observed by social network member B, thereby indicating that social network member C observes a higher degree of patient medical care instruction compliance than social network member B does in response to the query of step 210. Hence, the server 110 can further put social network member C in a new sending list for use in a subsequent query about medical care instruction compliance (identical to or different from medical care instructions targeted at by the query in step 200 or step 210.)

Therefore, it is feasible to treat social network member C as a member (i.e., the aforesaid “effective member”) who is willing to participate in observation of medical care instruction compliance and is influential in terms of reinforcing patients' resolve to follow medical care instructions strictly. A point to note is that, in case of a large number of social network members initially provided by patients, it will be feasible to repeat steps 210-216 until the final number of social network members in the sending list falls within a predetermined range of numbers. Afterward, the “effective members” are identified.

### Second Embodiment

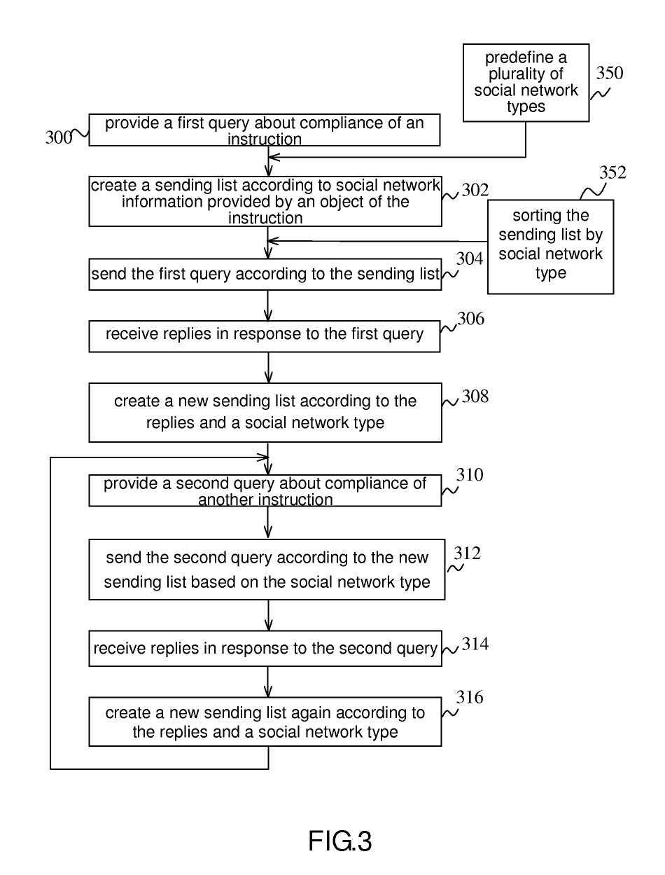

FIG. 3 is a flow chart of a method for observing and enhancing compliance with instructions via a social network by the system 100 of FIG. 1 according to another embodiment of the present invention. Basically, steps 300-316 of FIG. 3 are similar to steps 200-216 of FIG. 2, and thus only the differences therebetween are described below, especially the steps depicted in FIG. 3 but not depicted in FIG. 2.

Step 350: predefine in a database DB of the server 110 a plurality of social network types, such as (1) colleagues, (2) friends, and (3) family members. The social network types are predefined by the server 110, or are specified and named by patients independently. Related details are described, for example, in the rules of circle categorization set forth by Google Plus™.

Step 352: sorting the sending list of step 302 by social network type (including (1) colleagues, (2) friends, and (3) family members.)

Step 306: the server 110 receives replies from social network members enumerated in the sending list. Referring to Table 3 below, social network members enumerated in the sending list are denoted by A, B, C, D and sorted by (1) colleagues, (2) friends, and (3) family members.

TABLE 3

| social | | |
|---|---|---|
| network | | degree of |
| member | social network type | compliance |
| A | colleagues | 0 |
| B | friends | 1 |
| C | family members | 1 |
| D | family members | 0 |

Step 308: step 308 is different from step 208 of FIG. 2 in that, in step 308, the server 110 calculates the degree of compliance observed with respect to each social network type, for example, by adding up the patient compliance degree values observed by members of different social network types, or by calculating the average patient compliance degree value per member after the aforesaid addition process. In this embodiment, the patient compliance degree values observed by the social network type “friends” (i.e., member B) and the social network type “family members” (i.e., members C and D) are higher than the patient compliance degree values observed by the social network type “colleagues” (i.e., member A), thereby indicating that the social network type “friends” and the social network type “family members” observe higher patient compliance degree values than the social network type “colleagues” does. Hence, the server 110 can further put the social network type “friends” (i.e., member B) and the social network type “family members” (i.e., members C and D) on a new sending list.

Step 312: send the query provided in step 310 according to the new sending list (i.e., social network type “friends” (i.e., member B) and social network type “family members” (i.e., members C and D) of step 308.

Step 314: the server 110 receives replies from social network members enumerated in a new sending list, as shown in Table 4 below.

TABLE 4

| social | | |
|---|---|---|
| network | | degree of |
| member | social network type | compliance |
| B | friends | 0 |
| C | family members | 0 |
| D | family members | 1 |

Step 316: the patient compliance degree values observed by the social network type “family members” (i.e., members C and D) are higher than the patient compliance degree value observed by the social network type “friends” (i.e., member B), thereby indicating that the social network type “family members” observes a higher patient compliance degree value than the social network type “friends” does. Hence, the server 110 can further put the social network type “family members” (i.e., members C and D) in a new sending list for use in a subsequent query about medical care instruction (identical to or different from medical care instructions targeted at by the query of step 300 or step 310) compliance. Accordingly, members of the social network type “family members” will be deemed the aforesaid “effective members.”

### Third Embodiment

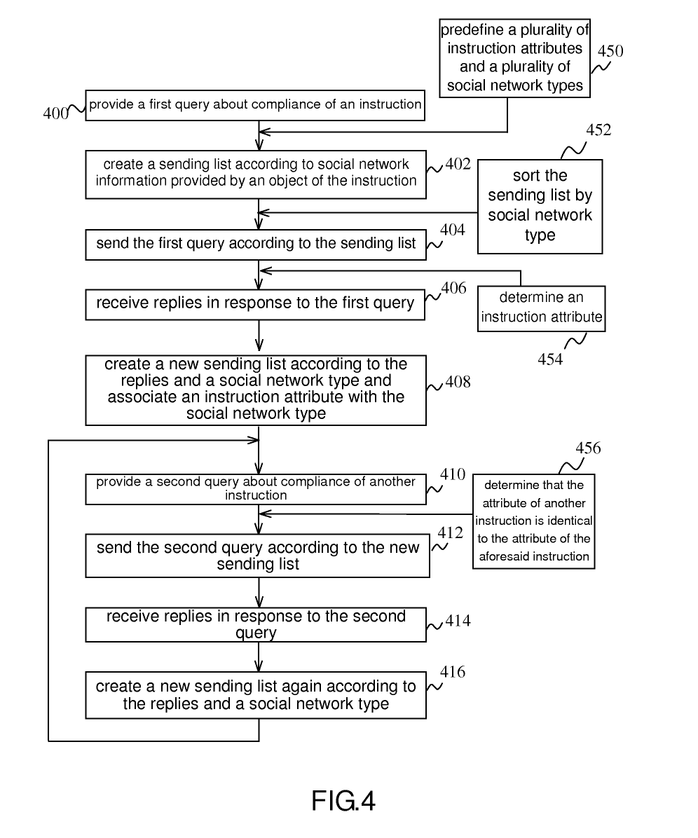

FIG. 4 is a flow chart of a method for observing and enhancing compliance with instructions via a social network by the system 100 of FIG. 1 according to another embodiment of the present invention. Basically, steps 400-416 of FIG. 4 are similar to steps 200-216 of FIG. 2, and thus only the differences therebetween are described below, especially the steps depicted in FIG. 4 but not depicted in FIG. 2.

Step 450: predefine in the database DB of the server 110 a plurality of social network types, such as (1) colleagues, (2) friends, and (3) family members, and a plurality of medical care instruction attributes, such as (1) food and drinks and (2) lifestyle. Like the social network types, the medical care instruction attributes are predetermined by the server 110 or specified and named by patients independently.

Step 452: see step 352 of FIG. 3.

Step 454: determine the medical care instruction attribute of step 400 to be (1) food and drinks or (2) exercise. In this embodiment, the medical care instruction of step 400 is “low-sodium food and drinks,” and thus it is feasible to determine its attribute to be (1) food and drinks.

Steps 404-406: see steps 304-306 of FIG. 3.

Step 408: see step 308 of FIG. 3. Step 408 is different from step 308 of FIG. 3 in that, in step 408, the server 110 associates the medical care instruction attribute “food and drinks” determined in step 454 with the social network types “friends” and “family members.”

Step 456: determine the medical care instruction attribute of step 410 to be (1) food and drinks or (2) exercise. In this embodiment, the medical care instruction of step 410 is “low-salt food and drinks,” and thus it is feasible to determine its attribute to be (1) food and drinks. In addition, step 456 further determines that the medical care instruction attribute of step 410 and the medical care instruction attribute of step 454 are identical and then go to step 412.

Steps 412-416: see steps 312-316 of FIG. 3. Steps 412-416 are not described in detail herein for the sake of brevity.

### Fourth Embodiment

FIG. 5 is a flow chart of a method for observing and enhancing compliance with instructions via a social network by the system 100 of FIG. 1 according to another embodiment of the present invention. Basically, steps 500-516 of FIG. 5 are similar to steps 200-216 of FIG. 2, and thus only the differences therebetween are described below, especially the steps depicted in FIG. 5 but not depicted in FIG. 2.

Step 550: predefine in the database DB of the server 110 a plurality of social network types, such as (1) colleagues, (2) friends, and (3) family members, and a plurality of medical care instruction attributes, such as (1) food and drinks and (2) lifestyle. Step 550 in FIG. 5 is different from step 450 in FIG. 4 in that, in step 550, each medical care instruction attribute matches at least a social network type. In this embodiment, as shown in Table 5 below, a point to note is that the correlation between the medical care instruction attributes and social network types is predefined by the server 110 or specified by patients.

TABLE 5

| medical care | |
|---|---|
| instruction attribute | social network type |
| food and drinks | friends, family members |
| lifestyle | colleagues |

Step 552: determine that the medical care instruction attribute in step 500 is (1) food and drinks or (2) exercise. In this embodiment, the medical care instruction in step 500 is “low-sodium food and drinks,” and thus its attribute is determined to be (1) food and drinks.

Step 554: the server 110 determines that the medical care instruction attribute “food and drinks” matches the social network types “friends” and “family members” by making reference to the association between the medical care instruction attributes and the social network types in the aforesaid Table 5.

Step 502: see step 202 in FIG. 2. However, this step does not require creating a sending list according to all the members (for example, members A, B, C, D) on a social network provided by the patients, otherwise the server 110 will create a sending list according to a portion of the members (including members B, C, D, but not including member A) on a social network provided by the patients if the portion of the members conforms with medical care instruction attribute “food and drinks” determined in step 552 and corresponds to social network types “friends” and “family members.”

Steps 504-516: see steps 204-216 in FIG. 2. Steps 504-516 are not described in detail herein for the sake of brevity.

### Fifth Embodiment

FIG. 6 is a flow chart of a method for observing and enhancing compliance with instructions via a social network by the system 100 of FIG. 1 according to another embodiment of the present invention. Basically, steps 600-616 of FIG. 6 are similar to steps 200-216 of FIG. 2, and thus only the differences therebetween are described below, especially the steps depicted in FIG. 6 but not depicted in FIG. 2.

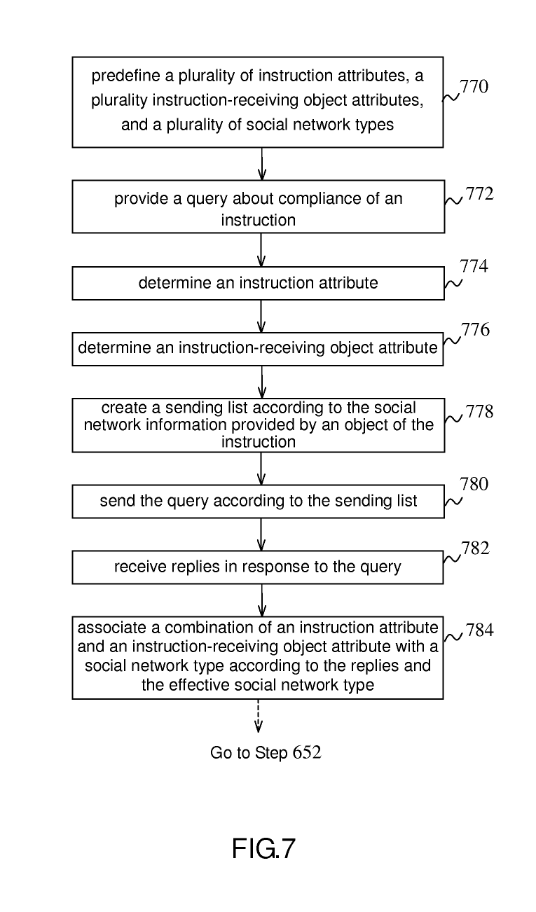

Step 650: predefine in the database DB of the server 110 a plurality of social network types, such as (1) colleagues, (2) friends, and (3) family members, a plurality of medical care instruction attributes, such as (1) food and drinks and (2) lifestyle, and a plurality of patient (that is, an object receiving a medical care instruction) attributes, such as (1) aged under 20, (2) aged 20 to 50, and (3) aged over 50. A point to note is that the patient attributes are not restricted to age but include gender, occupation, or a combination thereof. Step 650 is different from step 550 of FIG. 5 in that, in step 650, each combination of a patient attribute and a medical care instruction attribute matches at least one social network type. In this embodiment, as shown in Table 6 below, a point to note is that the way of associating a social network type with a combination of a patient attribute and a medical care instruction attribute is predetermined by the server 110, specified by patients, or determined by other means (for example, see the sixth embodiment (FIG. 7)).

TABLE 6

| | medical care | |
|---|---|---|
| | instruction | |
| patient attribute | attribute | social network type |
| aged under 20 | food and drinks | family members |
| aged under 20 | lifestyle | friends |
| aged 20 to 50 | lifestyle | colleagues |
| aged 20 to 50 | food and drinks | friends, family |
| | | members |
| aged over 50 | lifestyle | family members |
| . . . | . . . | . . . |

Step 652: determine that the medical care instruction attribute of step 600 is (1) food and drinks or (2) exercise. In this embodiment, the medical care instruction of step 600 is “low-sodium food and drinks,” and thus it is feasible to determine its attribute to be (1) food and drinks.

Step 654: determine that the attribute of an object receiving the medical care instruction of step 600 (i.e., patient attribute) is (1) aged under 20, (2) aged 20 to 50, or (3) aged over 50. In this embodiment, the attribute of an object receiving the medical care instruction of step 600 is 45 years old, and thus it is feasible to determine its attribute to be (2) aged 20 to 50.

Step 656: the server 110 determines that a combination of the patient attribute “aged 20 to 50” and the medical care instruction attribute “food and drinks” is associated with the social network types “friends” and “family members” by making reference to the association between a combination of a patient attribute and a medical care instruction attribute and a social network type in the aforesaid Table 6.

A point to note is that, not only is the aforesaid way of determining a corresponding social network type according to Table 6 and steps 652-656 deemed as an application of the “decision tree” concept, but the present invention also further expands it so as to cope with more quantitatively variable situations. For details of a “decision tree,” go to the website: http://en.wikipedia.org/wiki/Decision_tree

Step 602: see step 202 in FIG. 2. However, this step does not require creating a sending list according to all the members (for example, members A, B, C, D) on a social network provided by the patients, otherwise the server 110 will create a sending list according to a portion of the members (including members B, C, D, but not including member A) on a social network provided by the patients if the portion of the members conforms with patient attribute “aged 20 to 50” and medical care instruction attribute “food and drinks” determined in step 652 and corresponds to social network type “friends” and “family members”.

Steps 604-616: see steps 204-216 in FIG. 2. Steps 604-616 are not described in detail herein for the sake of brevity.

### Sixth Embodiment

FIG. 7 is a flow chart of a method for associating a combination of a patient attribute and a medical care instruction attribute with a social network type by the system 100 of FIG. 1 (that is, for example, creating each row of data of Table 6) according to another embodiment of the present invention.

Step 770: predefine in the database DB of the server 110 a plurality of social network types, such as (1) colleagues, (2) friends, and (3) family members, a plurality of medical care instruction attributes, such as (1) food and drinks and (2) lifestyle, and a plurality of patient (that is, an object receiving a medical care instruction) attributes, such as (1) aged under 20, (2) aged 20 to 50, and (3) aged over 50.

Step 772: provide a query about compliance of a medical care instruction.

Step 774: determine the medical care instruction attribute in step 772 to be (1) food and drinks or (2) exercise. In this embodiment, the medical care instruction of step 772 is “low-sodium food and drinks,”, and thus it is feasible to determine that its attribute is (1) food and drinks.

Step 776: determine attributes of objects receiving the medical care instruction of step 772, that is, patient attributes, to be (1) aged under 20, (2) aged 20 to 50, or (3) aged over 50. In this embodiment, if the attribute of an object receiving the medical care instruction in step 772 is 45 years old, it will be feasible to determine his/her attribute to be (2) aged 20 to 50.

Step 778: create a sending list and a sending schedule according to the social network information provided by an object (i.e., a patient) receiving the medical care instruction of step 772, wherein the sending list and the sending schedule are for use in sending the aforesaid query.

Step 780: send the query provided in step 772 according to the sending list of step 778. In this embodiment, the sending list enumerates social network members A, B, C, D.

Step 782: the server 110 receives replies from social network members enumerated in the sending list. Please refer to Table 3 (reproduced and presented below.)

TABLE 3

| social | | |
|---|---|---|
| network | | degree of |
| member | social network type | compliance |
| A | colleagues | 0 |
| B | friends | 1 |
| C | family members | 1 |
| D | family members | 0 |

Step 784: the server 110 calculates observed patients' degrees of compliance with respect to each social network type. In this embodiment, the observed patients' degrees of compliance for the social network type “friends” (i.e., member B) and the social network type “family members” (i.e., members C and D) are higher than that for the social network type “colleagues” (i.e., member A), thereby indicating that the social network type “friends” and the social network type “family members” have higher observed patients' degrees of compliance than the social network type “colleagues” does. Hence, the server 110 can further configure the social network type “friends” (i.e., member B) and the social network type “family members” (i.e., members C and D) as being of an “effective social network type.” Furthermore, step 784 involves associating a combination of the medical care instruction attribute “food and drinks” determined in step 774 and the patient attribute “aged 20 to 50” determined in step 776 with the effective social network type (that is, the social network type “friends” and the social network type “family members”.)

After accumulating sufficient samples (that is, a sufficiently large number of different patients and a sufficiently large number of different medical care instructions), the method can create a combination of a wide variety of patient attributes and medical care instruction attributes shown in Table 6, associate the combination with the social network types, and apply the association to the situation described in the fifth embodiment (FIG. 6). Similarly, according to the aforesaid description, persons skilled in the art understand how to create the association between a patient attribute and a social network type and apply the association to any situation that does not require giving considerations to a medical care instruction attribute or create the association between a combination of medical care instruction attributes and a social network type and apply the association to any situation that does not require giving considerations to a patient attribute.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

1. A method for observing and enhancing compliance with instructions via a social network by a computer system, the method comprising the steps of:
(a) providing a first query about compliance of a first instruction;
(b) creating a sending list according to social network information provided by an object of the first instruction;
(c) sending the first query according to the sending list;
(d) receiving from the sending list replies in response to the first query, wherein each reply selectively indicates one of multiple degrees of compliance;
(e) creating an effective sending list from the sending list according to the compliance indicated by the replies in step (d);
(f) providing a second query about compliance of a second instruction; and
(g) sending the second query according to the effective sending list.

2. The method of claim 1, wherein contents of the first instruction are identical to or different from contents of the second instruction.

3. The method of claim 1, wherein contents of the first query are identical to or different from contents of the second query.

4. The method of claim 1, further comprising the steps of:
creating a database predefining a plurality of social network types;
sorting the sending list by social network type in step (b); and
calculating compliance indicated by each social network type in the sending list to thereby select an effective social network type from the plurality of social network types and create the effective sending list according to a portion of the sending list on condition that the portion of the sending list belongs to the effective social network type, in step (e).

5. The method of claim 4, wherein the plurality of social network types is predefined in the database by an object of the first instruction.

6. The method of claim 1, further comprising the steps of:
creating a database predefining a plurality of instruction attributes and a plurality of social network types;
selecting an instruction attribute of the first instruction from the predefined plurality of instruction attributes;
selecting an instruction attribute of the second instruction from the predefined plurality of instruction attributes;
sorting the sending list by social network type in step (b);
calculating compliance indicated by each social network type in the sending list to thereby select an effective social network type from the plurality of social network types, creating an effective sending list according to a portion of the sending list if the portion of the sending list belongs to the effective social network type, and associating an instruction attribute of the first instruction with the effective social network type, in step (e); and
sending the second query according to the effective sending list, if an instruction attribute of the first instruction is identical to an instruction attribute of the second instruction, in step (g).

7. The method of claim 1, further comprising the steps of:
creating a database predefining a plurality of instruction attributes and a plurality of social network types, wherein each instruction attribute matches at least a social network type;
selecting an instruction attribute of the first instruction from the predefined plurality of instruction attributes;
determining a social network type matching an instruction attribute of the first instruction by making reference to the database;
creating a sending list according to a portion of the social network information, wherein the portion of the social network information belongs to a social network type matching an instruction attribute of the first instruction, in step (b).

8. The method of claim 1, further comprising the steps of:
creating a database predefining a plurality of object attributes, a plurality of instruction attributes, and a plurality of social network types, wherein a combination of each said object attribute and each said instruction attribute matches at least a social network type;
selecting an instruction attribute of the first instruction from the plurality of instruction attributes;
selecting an object attribute of an object of the first instruction from the plurality of object attributes;
determining a social network type matching a combination of an object attribute of an object of the first instruction and an instruction attribute of the first instruction by making reference to the database; and
creating a sending list according to a portion of the social network information, wherein the portion of the social network information belongs to a social network type matching a combination of an object attribute of an object of the first instruction and an instruction attribute of the first instruction, in step (b).

9. A method for observing and enhancing compliance with instructions via a social network by a computer system, the method comprising the steps of:
(a) providing a database predefining a plurality of object attributes and a plurality of social network types;
(b) selecting an object attribute of an object of a first instruction from the plurality of object attributes;
(c) providing a first query about compliance of the first instruction;
(d) creating a first sending list according to social network information provided by the object of the first instruction, and sorting the first sending list by social network type;
(e) sending the first query according to the first sending list;
(f) receiving from the first sending list replies in response to the first query, wherein each reply selectively indicates one of multiple degrees of compliance;
(g) calculating the compliance indicated by each social network type in the first sending list according to the replies in step (f) so as to select an effective social network type from the plurality of social network types and associate the object attribute of the object of the first instruction with the effective network type;
(h) providing a second query about compliance of a second instruction, and selecting an object attribute of an object of a second instruction from the plurality of object attributes; and
(i) creating a second sending list according to a portion of the social network information provided by the object of the second instruction and sending the second query according to the second sending list, wherein the portion of the social network information belongs to the effective social network type, on condition that the object attribute of the object of the first instruction and the object attribute of the object of the second instruction are identical.

10. The method of claim 9, further comprising the steps of:
(j) receiving from the second sending list a reply in response to the second query;
(k) creating an effective sending list from the second sending list according to the reply received in step (j);
(l) providing a third query about compliance of a third instruction; and
(m) sending the third query according to the effective sending list.

11. The method of claim 9, further comprising the sub-steps of:
predefining a plurality of instruction attributes in the database, in step (a);
selecting an instruction attribute of the first instruction from the predefined plurality of instruction attributes, in step (b);
associating a combination of an object attribute of an object of the first instruction and an instruction attribute of the first instruction with the effective social network type, in step (g);
selecting an instruction attribute of the second instruction from the predefined plurality of instruction attributes, in step (h); and
creating a second sending list according to a portion of the social network information provided by the object of the second instruction and sending the second query according to the second sending list, wherein the portion of the social network information belongs to the effective social network type, on condition that the object attribute of the object of the first instruction is identical to the object attribute of the object of the second instruction, and on condition that an instruction attribute of the first instruction is identical to an instruction attribute of the second instruction, in step (i).

12. A method for observing and enhancing compliance with instructions via a social network performed by a computer system, the method comprising the steps of:
(a) providing a database predefining a plurality of instruction attributes and a plurality of social network types;
(b) selecting an instruction attribute of a first instruction from the plurality of instruction attributes;
(c) providing a first query about compliance of the first instruction;
(d) creating a first sending list according to the social network information provided by the object of the first instruction, and sorting the first sending list by social network type;
(e) sending the first query according to the first sending list;
(f) receiving from the first sending list replies in response to the first query, wherein each reply selectively indicates one of multiple degrees of compliance;
(g) calculating the compliance indicated by each social network type in the first sending list according to the replies in step (f) so as to select an effective social network type from the plurality of social network types and associate the instruction attribute of the first instruction with the effective network type;
(h) providing a second query about compliance of a second instruction, and selecting an instruction attribute of a second instruction from the plurality of instruction attributes; and
(i) creating a second sending list according to a portion of the social network information, belonging to the effective social network type, provided by the object of the second instruction, and sending the second query according to the second sending list, on condition that the instruction attribute of a first instruction and instruction attribute of a second instruction are identical.

13. The method of claim 12, further comprising the steps of:
(j) receiving from the second sending list a reply in response to the second query;
(k) creating an effective sending list from the second sending list according to the reply received in step (j);
(l) providing a third query about compliance of a third instruction; and
(m) sending the third query according to the effective sending list.

14. A computer program product for observing and enhancing compliance with instructions via a social network, said computer program product comprising:
a tangible computer-readable device, comprising a computer-readable program to be executed by a computer system for implementing a method comprising:
(a) providing a first query about compliance of a first instruction;
(b) creating a sending list according to social network information provided by an object of the first instruction;
(c) sending the first query according to the sending list;
(d) receiving from the sending list replies in response to the first query, wherein each reply selectively indicates one of multiple degrees of compliance;
(e) creating an effective sending list from the sending list according to the compliance indicated by the replies in step (d);
(f) providing a second query about compliance of a second instruction; and
(g) sending the second query according to the effective sending list.

15. A computer system, comprising:
a host, comprising:
a bus system;
a memory connected to the bus system, wherein the memory comprising a computer executable instruction; and
a processing unit connected to the bus system, wherein the processing unit executes the computer executable instruction so as to implement a method comprising:
(a) providing a first query about compliance of a first instruction;
(b) creating a sending list according to social network information provided by an object of the first instruction;
(c) sending the first query according to the sending list;
(d) receiving from the sending list replies in response to the first query, wherein each reply selectively indicates one of multiple degrees of compliance;
(e) creating an effective sending list from the sending list according to the compliance indicated by the replies in step (d);
(f) providing a second query about compliance of a second instruction; and
(g) sending the second query according to the effective sending list.

16. The computer program product of claim 14, wherein said method further comprises:
creating a database predefining a plurality of social network types;
sorting the sending list by social network type in step (b); and
calculating compliance indicated by each social network type in the sending list to thereby select an effective social network type from the plurality of social network types and create the effective sending list according to a portion of the sending list on condition that the portion of the sending list belongs to the effective social network type, in step (e).

17. The computer program product of claim 16, wherein the plurality of social network types is predefined in the database by an object of the first instruction.

18. The computer program product of claim 14, further comprising the steps of:
creating a database predefining a plurality of instruction attributes and a plurality of social network types;
selecting an instruction attribute of the first instruction from the predefined plurality of instruction attributes;
selecting an instruction attribute of the second instruction from the predefined plurality of instruction attributes;
sorting the sending list by social network type in step (b);
calculating compliance indicated by each social network type in the sending list to thereby select an effective social network type from the plurality of social network types, creating an effective sending list according to a portion of the sending list if the portion of the sending list belongs to the effective social network type, and associating an instruction attribute of the first instruction with the effective social network type, in step (e); and
sending the second query according to the effective sending list, if an instruction attribute of the first instruction is identical to an instruction attribute of the second instruction, in step (g).

19. The system of claim 15, wherein said method further comprises:
creating a database predefining a plurality of social network types;
sorting the sending list by social network type in step (b); and
calculating compliance indicated by each social network type in the sending list to thereby select an effective social network type from the plurality of social network types and create the effective sending list according to a portion of the sending list on condition that the portion of the sending list belongs to the effective social network type, in step (e).

20. The system of claim 15, wherein said method further comprises:
creating a database predefining a plurality of instruction attributes and a plurality of social network types;
selecting an instruction attribute of the first instruction from the predefined plurality of instruction attributes;
selecting an instruction attribute of the second instruction from the predefined plurality of instruction attributes;
sorting the sending list by social network type in step (b);
calculating compliance indicated by each social network type in the sending list to thereby select an effective social network type from the plurality of social network types, creating an effective sending list according to a portion of the sending list if the portion of the sending list belongs to the effective social network type, and associating an instruction attribute of the first instruction with the effective social network type, in step (e); and
sending the second query according to the effective sending list, if an instruction attribute of the first instruction is identical to an instruction attribute of the second instruction, in step (g).
